(19) United States
(12) Patent Application Publication
(10) Pub. No.: US 2007/0112848 A1
(43) Pub. Date: May 17, 2007

(54) Method and system for concurrently processing multiple large data files transmitted using a multipart format

(76) Inventor: Steve Wang, Cary, NC (US)

Correspondence Address: LOTUS AND RATIONAL SOFTWARE;McGuinness & Manaras LLP, 125 NAGOG PARK, ACTON, MA, 01720, US

(21) Appl. No.: 11/281,962

(22) Filed: Nov. 17, 2005

(51) Int. Cl. G06F 7/00

(52) U.S. Cl. 707/103 R

(57) ABSTRACT

A system for concurrently processing data files in multipart format is disclosed. The disclosed system processes files transmitted from a client system to a server system in a multipart format. An object-oriented method for representing the multipart data is used on the server system, where the multipart data stream is parsed, and each file's content part is saved in a temporary file through a file system operating on the server system. A corresponding multipart container object is created that includes all relevant information regarding the multipart format the data files were received in. The container object stores a reference to each temporary file, such as a file name. The container object further provides methods that allow consumer programs to open up the temporary files in the file stream on-demand, and that delete the temporary files when the consumer program closes them. In this way the disclosed system advantageously eliminates the need to load the entire contents of a transferred file into memory, and preserves the on-demand property of the transmitted data retrieval.

### FIELD OF THE INVENTION

The present invention relates generally to software systems for electronic document management, and more specifically to a method and system for concurrently processing multiple large data files transmitted with a multipart format.

### BACKGROUND OF THE INVENTION

As it is generally known, many computer software programs operate in part by transmitting files from client software executing on a client computer system to server software executing on a server computer system. Many such systems operate over computer networks such as the Internet, for example in a World Wide Web (“Web”) service environment.

Document management systems are example of computer software systems that transfer files from client systems to server systems. Document management systems are used to manage electronic documents, and have become important applications for many users. Document management systems may be used by businesses or individuals to manage a wide variety of digital assets, such as documents, reports, invoices, forms, faxes, e-mails, audio, video and images, etc. Document management systems may, for example, include a database to organize the stored documents, and a search mechanism to quickly find specific documents.

Some existing document management systems enable a user to import document files from local sources on a client computer system, and then store the imported files onto a remote server system. Files that may be imported into such systems vary in size, and may be significantly large. Additionally, the number of users sharing such a system, and that may be concurrently importing files, may also be large. Previous solutions have uploaded all imported documents into server system memory, but that approach can have a negative impact on system performance. For example, poor performance may result from limited random access memory (RAM) space that can be allocated to a run time environment on the server. This limitation is present in systems such as those that employ run time environments such as the Java Virtual Machine (JVM). The resulting performance degradation may cause server systems to become unresponsive, and/or perform poorly when processing large documents.

In particular, Web applications generally consist of a browser program on a client computer system, operating as a front end for rendering content such as HTML and handling user interactions, and server side applications, such as a Java® Servlet, for handling data transmitted from the browser. When a need arises to upload file(s) from the browser to the server for further processing, scalability and performance are important considerations in these systems because of the potentially large number of concurrent users. Furthermore, the data files transmitted to the server may need to be accessible in a flexible way, in order to support on-demand retrieval and handling. Accordingly, the access and handling of the data files should not be tied to the sequential network I/O (“input/output”). Some technique for storing the uploaded data must be used that allows for decoupling of the files from the sequential network I/O. For relatively small sizes of transmitted data files, a memory buffer holding the entire file content may be sufficient in this regard. However, such an approach scales poorly when large amounts of file content are uploaded, or when there are large numbers of concurrent users, since the memory buffer size would have to increase in proportion to the uploaded data. In those cases the server system would become slow to respond due to heavy memory load ,or even crash. Moreover, such an approach becomes impractical if the file(s) being transferred have sizes in the hundreds of megabytes range.

For the above reasons and others, it would be desirable to have a new system for document management, that provides improved performance with regard to concurrently transferring large numbers of documents from a client system to a server system.

### SUMMARY OF THE INVENTION

To address the above described and other shortcomings of previous systems, a new method and system are disclosed for concurrently processing multiple large data files transmitted from a client system to a server system using a multipart format is disclosed. An object-oriented approach to representing the multipart data is used on the server system. The disclosed system advantageously allows flexible handling of files with the disclosed object-oriented design, and is easy to scale to large numbers of concurrent users and large sized document files. The disclosed system can be applied to a variety of client-server systems requiring concurrent importing and processing of large files.

In the disclosed system, data files are transmitted from a client computer system to a server computer system in a multipart format. For example, the multipart format could be form data submitted through an HTML browser agent in “multipart/form-data” format, or an electronic e-mail message submitted through an Internet mail agent. Any specific type or kind of client computer system software may be used to provide the data files to the server computer system in the multipart format.

On the application server system, the disclosed system operates to parse the multipart data stream, and save each file's content part in a temporary file through a file system operating on the server system. The temporary files generated by the disclosed system are represented outside of main memory, for example in a secondary storage device such as a magnetic storage disk or the like. The disclosed system also creates a corresponding multipart container object, which may be stored in memory on the server system. The multipart container object includes all relevant information regarding the multipart format the data files were received in, including a reference to each temporary file, such as a file name. The container object further provides methods that allow consumer programs of the transferred files to open up the temporary files in the file stream on-demand, and that delete the temporary files when the consumer program closes them. In this way the disclosed system advantageously eliminates the need to load the entire contents of a transferred file into memory, and preserves the on-demand property of the transmitted data retrieval for stream based operations.

Through the multipart container data object of the disclosed system, retrieval of large document contents is decoupled from the network input stream, and the files transferred from a client system to a server system can be obtained by consumer software on-demand. The file size to be processed through the disclosed system is only limited by network transmission limitations, and by server file system space that is relatively easy to scale.

Thus there is disclosed a new system for document management, that provides improved performance with regard to concurrently transferring large numbers of documents from a client system to a server system.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is a block diagram illustrating software components in an embodiment of the disclosed system;

FIG. 2 is a flow chart showing steps performed in an illustrative embodiment;

FIG. 3 shows an example of “multipart/form-data” encoding in an illustrative embodiment;

FIG. 4 shows an example of a multipart format for transferring files in an illustrative embodiment;

FIG. 5 shows a multipart data object in an illustrative embodiment;

FIG. 6 shows an example of a method for retrieving the contents of a file by opening a corresponding temporary file in an illustrative embodiment; and

FIG. 7 shows an example of an object providing a customized file input stream that removes a temporary file after closing.

### DETAILED DESCRIPTION OF EXEMPLARY EMBODIMENTS

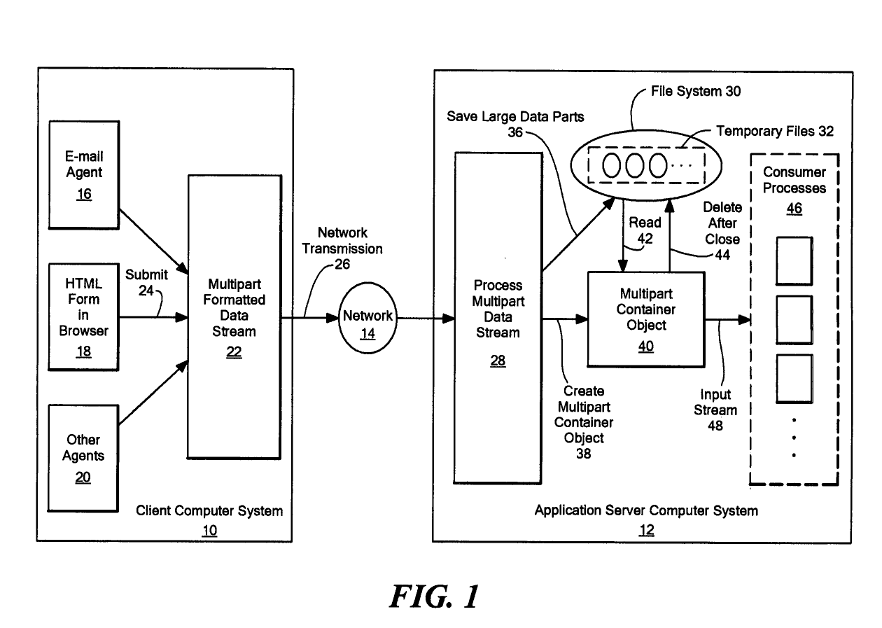

As shown in FIG. 1, an illustrative embodiment of the disclosed system operates using a number of software components executing on at least one client computer system 10 and at least one application server computer system. The client computer system 10 is shown including at least one client software program operable to generate a multipart formatted data stream 22, shown for purposes of illustration as e-mail agent 16, an HTML form processed by a browser program 18, and/or other software agents 20. For example, the multipart formatted data stream 24 may be generated as a result of the browser program processing a submit command 24. The multipart formatted data stream 22 is sent to the application server computer system 12 by way of network transmission, over network 14. The network 14 may consist of any specific type of data communication network, such as a Local Area Network (LAN), the Internet, or the like.

The application server computer system 12 receives the multipart formatted data stream 22, and a software process 28 operates to process the received multipart data stream. Processing of the received multipart formatted data stream includes saving 36 large data parts from the data stream, such as files contained within the data stream, into corresponding ones of the temporary files 32 contained within the file system 30. The file system 30 may advantageously store the temporary files within a secondary storage device, such as a magnetic disk or the like. Processing of the received multipart formatted data stream at the application server computer system further includes creating 38 a multipart container object 40. The multipart container object 40 may advantageously be stored in a high speed memory, such as a RAM (Random Access Memory), contained within the application server computer system. The multipart container object 40 is operable to read 42 the temporary files 32 from the file system 30, and to provide the contents of the temporary files 32 to the consumer processes 46 as part of a file input stream 48. Examples of consumer processes 46 include a database for permanently storing the files from the multipart formatted datastream, such as an electronic mail (e-mail) database, an indexing service for creating a search index for the contents of the files from the multipart formatted datastream, or another specific type of server process executing on the application server computer system. The multipart container object 40 is further operable to delete the temporary files 32 from the file system 30 in response to operations from the consumer processes 46 requesting that the files stored in them be closed. Operation of the components in the embodiment illustrated in FIG. 1 is further described below.

The client computer system 10 and application server computer system 12 may each, for example, include at least one processor, primary program storage, such as memory, for storing program code executable on the processor, secondary storage, such as one or more magnetic disks or other secondary storage devices, on which files, such as those files managed by the file system 30, may be stored, and one or more other input/output devices and/or interfaces, such as data communication and/or peripheral devices and/or interfaces. The client computer system 10 and application server computer system 12 may each further include appropriate operating system and or other run-time software.

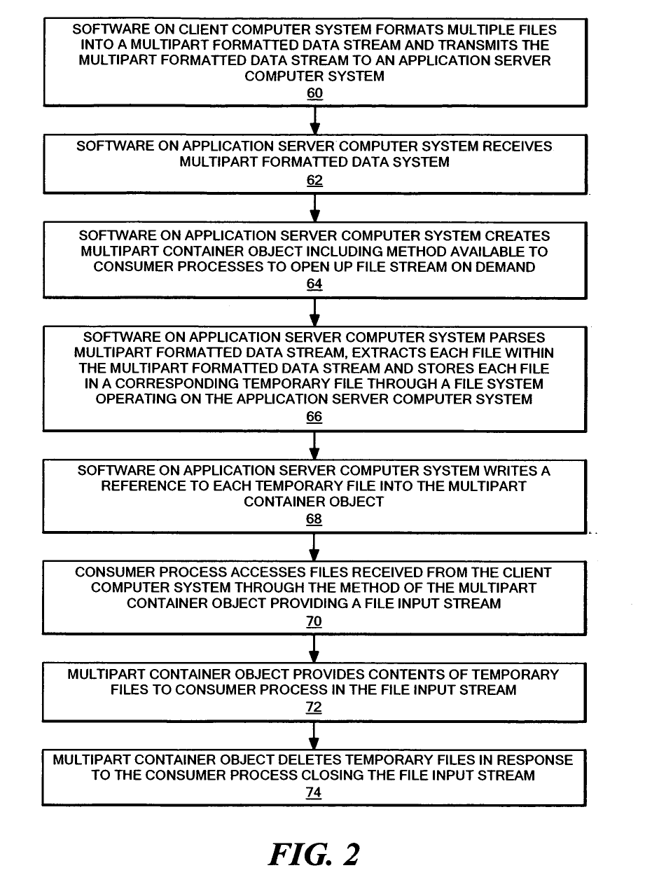

FIG. 2 is a flow chart illustrating steps performed by an embodiment of the disclosed system. At step 60, software on a client computer system formats multiple files to be uploaded to an application server computer system into a multipart formatted data stream, and transmits the multipart formatted data stream to the application server computer system. At step 62 software on the application server computer system receives the multipart formatted data stream. Next, at step 64, software on the application server computer system creates a multipart container object including a method available to a number of consumer processes that is operable to open up a file stream conveyed by the received multipart formatted data stream on demand.

At step 66, software on the application server computer system parses the received multipart formatted data stream to extract each file contained within the received multipart formatted data stream. Further at step 66, the files contained within the received multipart formatted data stream are stored in corresponding temporary files provided through a file system operating on the application server computer system. The temporary files may, for example, be stored on a secondary storage device, such as a magnetic disk, thus obviating the need to completely store all the received files in the main memory of the application server computer system.

At step 68, software on the application computer system writes a reference to each temporary file stored through the file system on the application server computer system into the multipart container object. Such references to the temporary files may, for example, consist of file names of the corresponding temporary files.

In step 70, a consumer process executing in the application server computer system, which may include any specific type of server application program, such as an indexing process, database program, e-mail application server, Web-based content management server, or other consumer process, operates to access the files received in the multipart formatted data stream from the client computer system by invoking a method provided by the multipart container object formed on the application server computer system. In this way, the consumer process accesses a file input stream provided by the multipart container object.

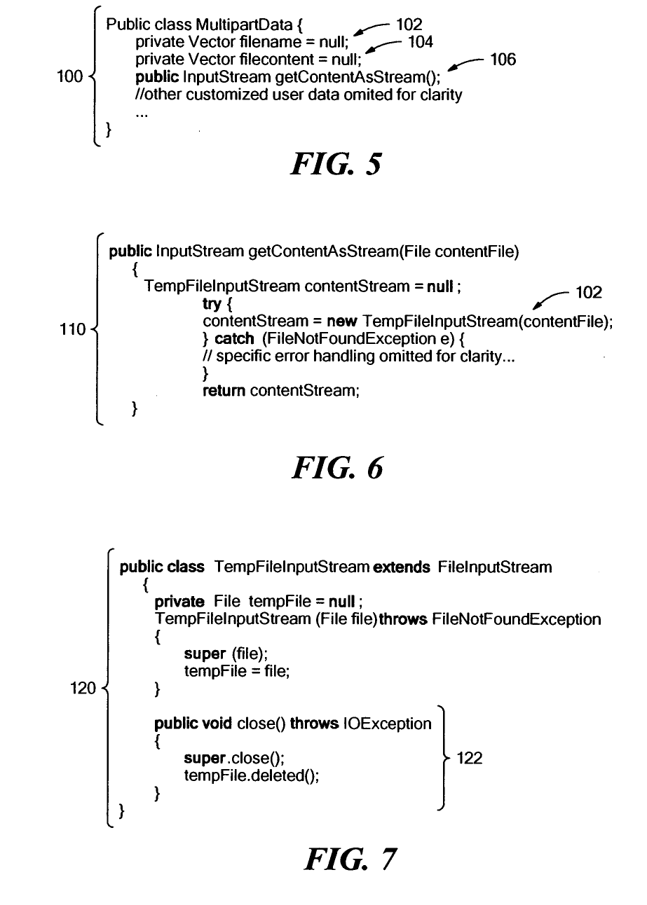

The consumer process refers to the files it consumes through file references stored in the container object. As described further below, and shown in FIGS. 5 and 6, the disclosed container object may include a method, such as the illustrative method getContentAsStream, to access the actual file data. The consumer process can select any file and open it. The specific files to be consumed are defined by a protocol between the client agent software and the server consumer process. For example, where the consumer process on the application server computer system is the server portion of a client-server application, it may operate to fulfill service requests from client application software executing on the client computer system, and those service requests involve consuming files provided from the client computer system.

The multipart container object provides the contents of the temporary files to the consumer process as part of the file input stream at step 72. At step 74, the multipart container object processes a request from the consumer process to close the file input stream by, at least in part, deleting one or more of the temporary files previously provided to the consumer process through the file input stream.

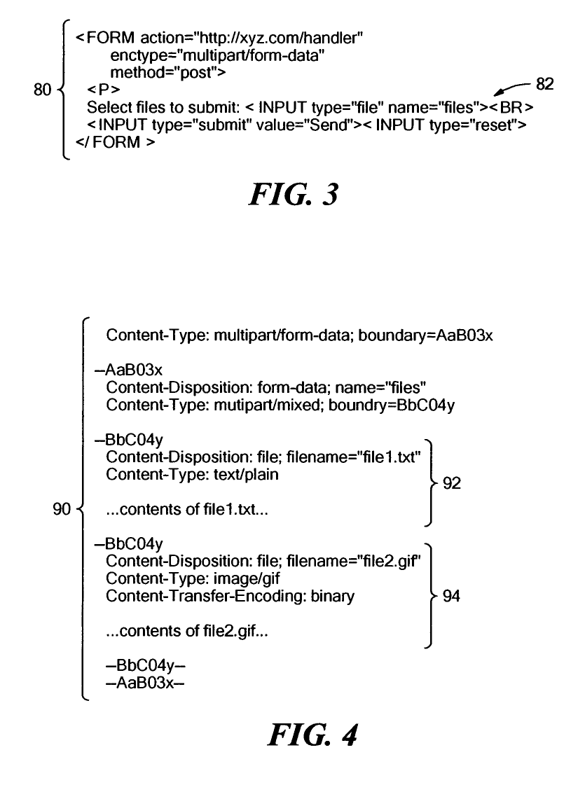

In FIG. 3 the code 80 is an example of HTML (HyperText Markup Language) form illustrating “multipart/form-data” encoding. The code 80 may, for example, be provided from a Web page document, and processed by a browser application program executing in a client computer system. The code example of FIG. 3 illustrates one way in which software on a client computer system, such as the client computer system 10 in FIG. 1, can generate the multipart formatted data stream 22 also shown in FIG. 1 from an electronic form. As shown by the code statement 82, the code 80 allows the user to select multiple files to be submitted into the multipart formatted data stream.

For example, if a user on the client computer system selected two files “file1.txt” and “file2.gif”, agent software on the client computer system, such as the browser program, would construct the parts of the multipart formatted datastream 22 of FIG. 1 as illustrated by the datastream 90 of FIG. 4. The datastream 90 is accordingly a further illustration of HTML multipart form submission, as in one embodiment of the disclosed system. The contents of file1.txt would be contained within the datastream-segment 92, and the contents of file2.gif would be contained within the datastream segment 94.

FIG. 5 shows an example of a multipart data object 100, as is created by the disclosed system on the application server computer system in response to receipt of the multipart formatted datastream. In the example of FIG. 5, the “filename” vector 102 is used to hold the names of the files submitted by the user on the client computer system, and contained within the multipart formatted datastream. The file names stored in the “filename” vector 102 are part of the metadata contained in the multipart formatted datastream, and are extracted when software on the application server computer system parses the received multipart formatted datastream. The “filecontent” vector 104 represents temporary files storing the contents of files extracted from the received multipart formatted datastream at the application server computer system. For example, the contents of the extracted files may be stored in temporary files created and accessed through a file system on the application server computer system. In such a case, the file names of those temporary files, as understood by the file system on the application server computer system, may be stored in the “filecontent” vector 104. In this way, each entry of the “filecontent” vector 104 is used to represent contents associated with a file in the received multipart formatted datastream, and having a file name extracted from the multipart formatted datastream stored in a corresponding entry of the “filename” vector 102. For example, each entry in the “filecontent” vector 104 may consist of a “File” type object.

The public “InputStream” method allows a consumer process on the application server computer system to obtain the files contained in the received multipart formatted datastream through the multipart data object 100.

The multipart data object 100 may be used to store any metadata extracted from the multipart formatted datastream. In addition to the file names stored in the “filename” vector 102, such metadata may include any other relevant information describing the files extracted from the multipart formatted datastream. Such metadata may include, for example, the length, type, and/or other characteristics of the extracted files. Such information stored in the multipart data object 100 is also made available to the consuming processes on the application server computer system.

FIG. 6 shows an example of code 110 used to define the method used by a consumer process on the application server computer system to retrieve the contents of a file submitted by an agent on the client computer system into the multipart formatted data stream. The code 110 operates to retrieve such contents by opening the corresponding temporary file through the file system on the application server computer system. The “TempFileInputStream” object 102 in the code 110 defines a customized file input stream that is designed to delete the temporary file after closing it. In the example of FIG. 6, the consumer process calls the TempFileInputStream method close ( ), and TempFileInputStream will close the temporary file and remove it. An example 120 of code that defines the “TempFileInputStream” object 102 is shown in FIG. 7. The code segment 122 illustrates one possible approach to deleting a temporary file after it has been closed.

The multipart formatted datastream used to transmit submitted files from a client computer system to an application server computer system may, for example, conform to the multipart format outlined in RFC2045 (“Multipurpose Internet Mail Extensions (MIME) Part One: Format of Internet Message Bodies”, N. Freed and N. Borenstein, November 1996.). As noted above, such a multipart formatted datastream can, for example, consist of form data submitted through an HTML browser agent with “multipart/form-data” format. Alternatively, the multipart formatted datastream can consist of an electronic mail (“e-mail”) message or messages submitted through an Internet mail agent software program executing on the client computer system, and that follows IANA (Internet Assigned Numbers Authority) specifications found in “Assigned Numbers”, STD 2, RFC 1700, USC/ISI, J. Reynolds and J. Postel, October 1994.

Many advantages are provided by the disclosed system. These include removing the need to store complete files from a received datastream in main memory of an application server computer system while these files are accessed by one or more consuming processes. Additionally, the files in the received datastream are made available to consumer processes “on-demand”, in that they are available to be consumed as soon as they are received at the application server computer system. When uploading potentially large files, such as from a browser at a client computer to a server for further processing, the disclosed object oriented representation of the uploaded files decouples the sequential data of a received network input/output (I/O) stream from accesses to the received file data performed by consuming application server software processes. Moreover, the size of files processed through the disclosed system is only limited by the capabilities of the network, which are typically sufficient in this regard, and by server file system space, which is relatively easy to scale.

FIGS. 1 and 2 are block diagram and flowchart illustrations of methods, apparatus(s) and computer program products according to an embodiment of the invention. It will be understood that each block of FIGS. 1 and. 2, and combinations of these blocks, can be implemented by computer program instructions. These computer program instructions may be loaded onto a computer or other programmable data processing apparatus to produce a machine, such that the instructions which execute on the computer or other programmable data processing apparatus create means for implementing the functions specified in the block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block or blocks.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using wireless, baseband signaling or broadband signaling techniques, including carrier wave signaling-techniques, such as over computer or telephone networks via a modem.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative program command structures, one skilled in the art will recognize that they may be embodied using a variety of specific command structures.

I claim:

1. A method for concurrently processing data files transmitted from a client system to a server system, comprising:
receiving, from at least one client computer system, a multipart data stream at a server computer system, wherein said multipart data stream contains a plurality of received data files;
parsing the received multipart data stream at said server computer system to extract said plurality of received data files;
saving the content of each of said plurality of received data files into a corresponding one of a plurality of temporary files in a file system on said server computer system;
creating a multipart container object on said server computer system, wherein said multipart container object represents each of said plurality of received data files, and wherein said multipart container object includes a reference for each one of said plurality of temporary files;
wherein said multipart container object further includes a method operable to open one of said plurality of temporary files corresponding to an indicated one of said plurality of received data files; and
wherein said multipart container object further includes a method operable to close said one of said plurality of temporary files corresponding to said indicated one of said received data files, and wherein said method operable to close said indicated one of said received data files also operates, when invoked, to automatically delete said corresponding one of said plurality of temporary files.

2. The method of claim 1, wherein said reference for each one of said plurality of temporary files comprises a file name understood by said file system of said server computer system.

3. The method of claim 2, wherein said multipart container object represents said each of said plurality of received data files through storing file names extracted from said multipart data stream.

4. The method of claim 1, further comprising generating said multipart data stream at a client computer system in response to an electronic form submitted through a browser program.

5. The method of claim 1, further comprising providing a contents of at least one of said plurality of temporary files to a consumer process on said server computer system, wherein said consumer process on said server computer system invokes said method operable to open said at least one of said plurality of received data files and said method operable to close said at least one of said plurality of received data files.

6. The method of claim 5, wherein said consumer process comprises a database.

7. The method of claim 5, wherein said consumer process comprises an document indexing process.

8. A system including a computer readable medium, said computer readable medium having program code stored thereon for concurrently processing data files transmitted from a client system to a server system, said program code comprising:
program code for receiving, from at least one client computer system, a multipart data stream at a server computer system, wherein said multipart data stream contains a plurality of received data files;
program code for parsing the received multipart data stream at said server computer system to extract said plurality of received data files;
program code for saving the content of each of said plurality of received data files into a corresponding one of a plurality of temporary files in a file system on said server computer system;
program code for creating a multipart container object on said server computer system, wherein said multipart container object represents each of said plurality of received data files, and wherein said multipart container object includes a reference for each one of said plurality of temporary files;
wherein said multipart container object further includes a method operable to open one of said plurality of temporary files corresponding to an indicated one of said plurality of received data files; and
wherein said multipart container object further includes a method operable to close said one of said plurality of temporary files corresponding to said indicated one of said received data files, and wherein said method operable to close said indicated one of said received data files also operates, when invoked, to automatically delete said corresponding one of said plurality of temporary files.

9. The system of claim 8, wherein said reference for each one of said plurality of temporary files comprises a file name understood by said file system of said server computer system.

10. The system of claim 9, wherein said multipart container object represents said each of said plurality of received data files through storing file names extracted from said multipart data stream.

11. The system of claim 8, further comprising generating said multipart data stream at a client computer system in response to an electronic form submitted through a browser program.

12. The system of claim 8, further comprising providing a contents of at least one of said plurality of temporary files to a consumer process on said server computer system, wherein said consumer process on said server computer system invokes said method operable to open said at least one of said plurality of received data files and said method operable to close said at least one of said plurality of received data files.

13. The method of claim 12, wherein said consumer process comprises a database.

14. The method of claim 12, wherein said consumer process comprises an document indexing process.

15. A computer program product including a computer readable medium, said computer readable medium having program code stored thereon for concurrently processing data files transmitted from a client system to a server system, said program code comprising:
program code for receiving, from at least one client computer system, a multipart data stream at a server computer system, wherein said multipart data stream contains a plurality of received data files;
program code for parsing the received multipart data stream at said server computer system to extract said plurality of received data files;
program code for saving the content of each of said plurality of received data files into a corresponding one of a plurality of temporary files in a file system on said server computer system;
program code for creating a multipart container object on said server computer system, wherein said multipart container object represents each of said plurality of received data files, and wherein said multipart container object includes a reference for each one of said plurality of temporary files;
wherein said multipart container object further includes a method operable to open one of said plurality of temporary files corresponding to an indicated one of said plurality of received data files; and
wherein said multipart container object further includes a method operable to close said one of said plurality of temporary files corresponding to said indicated one of said received data files, and wherein said method operable to close said indicated one of said received data files also operates, when invoked, to automatically delete said corresponding one of said plurality of temporary files.

16. A computer data signal embodied in a carrier wave, said computer data signal having stored thereon program code for concurrently processing data files transmitted from a client system to a server system, said program code comprising:
program code for receiving, from at least one client computer system, a multipart data stream at a server computer system, wherein said multipart data stream contains a plurality of received data files;
program code for parsing the received multipart data stream at said server computer system to extract said plurality of received data files;
program code for saving the content of each of said plurality of received data files into a corresponding one of a plurality of temporary files in a file system on said server computer system; program code for creating a multipart container object on said server computer system, wherein said multipart container object represents each of said plurality of received data files, and wherein said multipart container object includes a reference for each one of said plurality of temporary files;
wherein said multipart container object further includes a method operable to open one of said plurality of temporary files corresponding to an indicated one of said plurality of received data files; and
wherein said multipart container object further includes a method operable to close said one of said plurality of temporary files corresponding to said indicated one of said received data files, and wherein said method operable to close said indicated one of said received data files also operates, when invoked, to automatically delete said corresponding one of said plurality of temporary files.

17. A system for concurrently processing data files transmitted from a client system to a server system, comprising:
means for receiving, from at least one client computer system, a multipart data stream at a server computer system, wherein said multipart data stream contains a plurality of received data files;
means for parsing the received multipart data stream at said server computer system to extract said plurality of received data files;
means for saving the content of each of said plurality of received data files into a corresponding one of a plurality of temporary files in a file system on said server computer system;
means for creating a multipart container object on said server computer system, wherein said multipart container object represents each of said plurality of received data files, and wherein said multipart container object includes a reference for each one of said plurality of temporary files;
wherein said multipart container object further includes a method operable to open one of said plurality of temporary files corresponding to an indicated one of said plurality of received data files; and
wherein said multipart container object further includes a method operable to close said one of said plurality of temporary files corresponding to said indicated one of said received data files, and wherein said method operable to close said indicated one of said received data files also operates, when invoked, to automatically delete said corresponding one of said plurality of temporary files.
